(19) United States
(12) Patent Application Publication
(10) Pub. No.: US 2022/0398509 A1
(43) Pub. Date: Dec. 15, 2022

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Naoya OKA, Nagakute-shi (JP); Satoshi KITAMURA, Nagoya-shi (JP); Yusuke SOBUE, Nagoya-shi (JP); Seira NAKADA, Nagoya-shi (JP); Mami MORI, Nagoya-shi (JP); Masato MORISHIMA, Nagoya-shi (JP); Yasuyuki NUNOKAWA, Nagoya-shi (JP)

(73) Assignee: TOYOTA JIDOSHA KABUSHIKI KAISHA, Toyota-shi (JP)

(21) Appl. No.: 17/825,117

(22) Filed: May 26, 2022

(30) Foreign Application Priority Data
Jun. 10, 2021 (JP) 2021-097569

(51) Int. Cl. G06Q 10/02

(52) U.S. Cl. CPC G06Q 10/025

(57) ABSTRACT

An information processing device includes a controller configured to: obtain data related to a service received by each of a plurality of users at one or more spots; and determine an incentive provided in a given area, based on the number of the users each receiving the service at the one or more spots included in the given area.

### CROSS-REFERENCE TO RELATED APPLICATION

This application claims priority to Japanese Patent Application No. 2021-097569 filed on Jun. 10, 2021, incorporated herein by reference in its entirety.

### BACKGROUND

### 1. Technical Field

The disclosure relates to an information processing device and an information processing method.

### 2. Description of Related Art

A service that provides incentives to traveling users is known. In this connection, Japanese Unexamined Patent Application Publication No. 2006-293704 (JP 2006-293704 A) discloses a system that sends a coupon or other discount information to a mobile device, according to the location information and date/time information on the mobile device.

### SUMMARY

The disclosure provides an information processing device that efficiently issues incentives to traveling users.

An information processing device according to a first aspect of the disclosure includes a controller configured to obtain data related to a service received by each of a plurality of users at one or more spots, and determine an incentive provided in a given area, based on the number of the users each receiving the service at the one or more spots included in the given area.

An information processing method according to a second aspect of the disclosure includes: obtaining data related to a service received by each of a plurality of users at one or more spots; and determining an incentive provided in a given area, based on the number of the users each receiving the service at the one or more spots included in the given area.

According to the disclosure, it is possible to efficiently issue incentives to traveling users.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view useful for briefly describing a reservation system;

FIG. 2 is a view illustrating the configuration of a reservation server and a user terminal;

FIG. 3 shows an example of spot data stored in a storage unit;

FIG. 4 shows an example of plan data stored in the storage unit;

FIG. 5 shows an example of reservation data generated by the reservation server;

FIG. 6 shows an example of coupon data stored in the storage unit;

FIG. 7 is a flowchart of a first process performed by a controller in a first embodiment;

FIG. 8 is a flowchart of the first process performed by the controller in the first embodiment;

FIG. 9 is a flowchart of a second process performed by the controller in the first embodiment;

FIG. 10 shows one example of a screen on which issuance of a coupon is offered;

FIG. 11 shows an example of aggregate results in a second embodiment; and

FIG. 12 shows an example of coupon data in the second embodiment.

### DETAILED DESCRIPTION OF EMBODIMENTS

An information processing device according to one aspect of the disclosure has a controller that obtains data related to a service received by each of a plurality of users at one or more spots, and determines an incentive provided in a given area, based on the number of the users each receiving the service at the spot or spots included in the given area.

The information processing device is a device that provides services related to traveling. Examples of the services include, for example, a service to generate travel plans, a service to make reservations all at once for two or more spots (e.g., an accommodation facility, restaurant, parking lot, etc.) to be visited during a trip. The controller determines the incentive provided in the given area, based on the number of the users each receiving the service at the spot or spots included in the given area. The incentive may be a coupon that can be used in a shop, facility, or the like. According to this aspect, in an area where a large number of users gather, coupons, etc. can be efficiently distributed to the users, so as to encourage further consumption.

The data may include reservation data related to reservations made by the users for the one or more spots. Also, the reservation data may include information that identifies a target spot to be reserved, and a reservation time. The user who reserves a spot is supposed to stay at the spot, before and after the reservation time. Thus, it is possible to estimate the number of users present in the given area so as to receive the service at a certain point in time, based on the reservation data.

The controller may be configured to make an estimation of the number of the users each staying to receive the service in the given area, based on the reservation data, and determine the incentive, based on a result of the estimation. Also, the controller may be configured to determine that the incentive is provided, when the number of the users staying in the given area exceeds a predetermined value. With this configuration, the incentives can be issued to encourage more consumption at the time when it is determined that a large number of users gather in a certain area.

The predetermined value may be set based on current circumstances of the given area. For example, the optimum predetermined value may be determined, based on the weather and temperature in the area.

The reservation data may further include information that identifies a content of the service received by each of the users. Also, the controller may be configured to identify the service received by each of the users staying in the given area, and the controller may be configured to determine the incentive, based on the number of the users for the service. Thus, for an area having a large number of lunch reservations, for example, it is possible to curb or prevent the issuance of coupons for lunch, and issue other coupons.

The controller may be configured to send the determined incentive, to user devices corresponding to the users located in the given area. Also, the controller may be configured to send the determined incentive, to user devices corresponding to the users each scheduled to receive the service in the given area. Namely, the incentives can be distributed to the users who are currently visiting the given area or who are expected to visit the area.

The controller may be configured to send the determined incentive, to user devices corresponding to the users each scheduled to receive a service other than a service offered by the incentive. With this configuration, it is possible to curb or prevent a situation where an incentive for an overlapping service is issued, for example, a situation where a coupon for lunch at another restaurant is issued to a user who has made a reservation for lunch.

The incentive may include a discount or free service provided in any of the one or more spots included in the given area. Also, the controller may be configured to generate electronic data corresponding to the incentive. The electronic data may be transmitted in a non-contact manner, or may be in the form of a bar code or a two-dimensional code, which can be optically read.

Some specific embodiments of the disclosure will be described based on the drawings. The hardware configuration, module configuration, functional configuration, etc. described in each embodiment are not intended to limit the technical scope of the disclosure only to the configurations unless particularly stated otherwise.

### First Embodiment

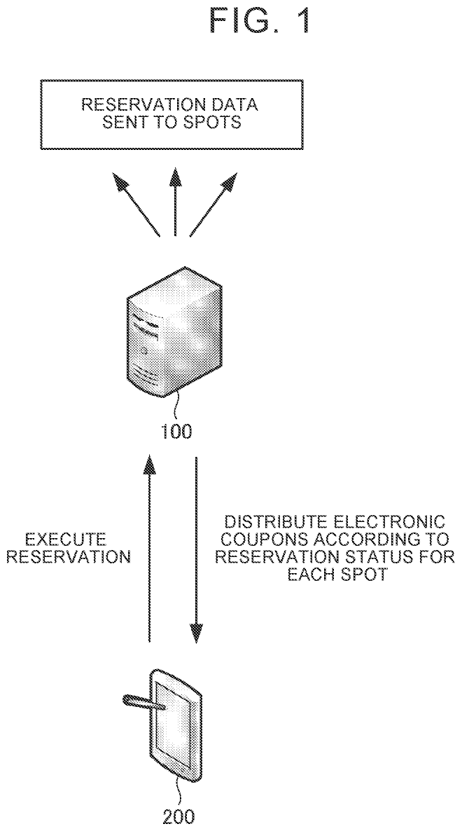

A reservation system according to a first embodiment will be briefly described with reference to FIG. 1. The reservation system according to this embodiment includes a reservation server 100 that makes reservations for two or more spots (e.g., an accommodation facility and a restaurant) all at once, and one or more user terminals 200.

The reservation server 100 is a device that generates reservation data to reserve two or more spots registered in advance, based on a request transmitted from a user terminal 200. The reservation server 100 manages a plurality of spots, and plans provided at the spots, and can reserve the spots and plans, based on requests from users.

The user terminal 200 is a computer owned by a user who uses the reservation service. The user can access the reservation server 100 via the user terminal 200, and request reservations for two or more spots. The user may also send desired conditions (e.g., desired region, desired spot attributes, departure time, etc.) to the reservation server 100.

Furthermore, the reservation server 100 issues an electronic coupon that can be used by the user, based on the reservation status for each of the spots included in a given area. For example, when there is an area having a large number of reservations, it is possible to encourage further consumption in the area, by issuing electronic coupons in the area.

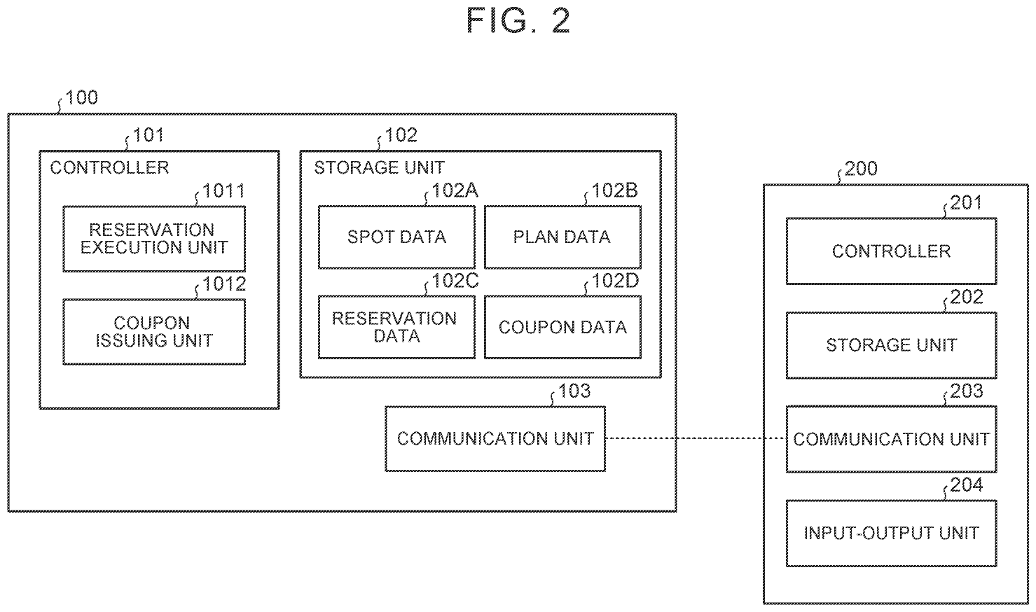

FIG. 2 shows, in more detail, constituent elements of the reservation server 100 and user terminal 200, which are included in an information processing system according to the embodiment. Initially, the user terminal 200 will be described. The user terminal 200 is a computer, such as a personal computer, smartphone, mobile phone, tablet computer, or personal information terminal, which is used by an individual. The user terminal 200 includes a controller 201, storage unit 202, communication unit 203, and input-output unit 204.

The controller 201 is a computing device that controls operation performed by the user terminal 200. The controller 201 can be realized by an arithmetic processor, such as a central processing unit (CPU). The controller 201 performs the function of accessing and interacting with the reservation server 100. The function may be implemented by a web browser that runs on the user terminal 200, or by dedicated application software.

The storage unit 202 includes a main storage device and an auxiliary storage device. The main storage device is a memory in which programs executed by the controller 201 and data used by the control programs are developed. The auxiliary storage device is a device in which programs executed by the controller 201 and data used by the control programs are stored. The auxiliary storage device may store programs to be executed by the controller 201 such that the programs are packaged as applications. Also, an operating system for executing these applications may be stored. In operation, a program stored in the auxiliary storage device is loaded into the main storage device and executed by the controller 201, so that a process that will be described below is performed.

The main storage device may include a random access memory (RAM) and a read-only memory (ROM). The auxiliary storage device may include an erasable programmable ROM (EPROM) and a hard disk drive (HDD). Furthermore, the auxiliary storage device may include removable media, i.e., portable storage media.

The communication unit 203 is a wireless communication interface for connecting the user terminal 200 to a network. The communication unit 203 is configured to be able to communicate with the reservation server 100, via a mobile communication service, such as wireless LAN (Local Area Network), 3G, LTE (Long Term Evolution), and 5G. The input-output unit 204 accepts input operation performed by the user, and presents information to the user. In this embodiment, the input-output unit 204 is in the form of a single touch panel display. Namely, the input-output unit 204 consists of a liquid crystal display and its controller, and a touch panel and its controller.

Next, the reservation server 100 will be described. The reservation server 100 is a server device that presents a plurality of spots and the contents of plans to the user, and makes a reservation for a spot, based on a request sent from the user terminal 200.

In this embodiment, the reservation server 100 may be configured to be able to implement a web server for interacting with the user terminal 200. In this case, for example, the user terminal 200 accesses the web server using a browser, so that the user can make a reservation for a spot. The reservation server 100 may offer the service by any means other than the web server. For example, a service that allows interactions using a dedicated application software installed on the user terminal 200 and a predetermined protocol may be implemented in the reservation server 100.

The reservation server 100 may be provided by a general-purpose computer. Namely, the reservation server 100 may be configured as a computer having a processor such as a CPU or graphics processing unit (GPU), a main storage device such as a RAM or ROM, and an auxiliary storage device such as EPROM, hard disk drive, or removable medium. The auxiliary storage device stores an operation system (OS), various programs, various tables, etc., and a program stored therein is loaded into a working area of the main storage device and executed, so that each component, etc. is controlled through execution of the program. In this manner, each function that meets a specified purpose can be implemented, as will be described later. However, some or all of the functions may be implemented by hardware circuits, such as application specific integrated circuits (ASICs) and field programmable gate arrays (FPGAs).

The controller 101 is a computing device that controls operation performed by the reservation server 100. The controller 101 can be realized by an arithmetic processor such as a CPU. The controller 101 has two function modules, i.e., a reservation execution unit 1011 and a coupon issuing unit 1012. Each of the function modules may be implemented by causing the CPU to execute a stored program.

The reservation execution unit 1011 determines spots and plans to be used by the user during a trip, based on the results of interaction with the user terminal 200, and generates reservation data. In this embodiment, the spots mean facilities used by users. Examples of the spots include accommodation facilities, restaurants, and entertainment facilities, for example. Furthermore, the spots may be facilities such as a parking lot, a car wash, and a gas station, which provide services related to automobiles. Further, the spots may be facilities (experience-type facilities) that provide activities and experiences. This type of facilities may include, for example, facilities where the users can experience particular occupations such as agriculture, sports, cruising, and sightseeing flights.

In this embodiment, plans identify services provided at each of the spots. When the spot is an accommodation facility, examples of the plans include “single room, one night”, “single room, one night (with breakfast)”, and “double room, one night”. When the spot is a restaurant, examples of the plans include “course meal (lunch)” and “course meal (dinner)”. In addition, the plans may be set in any way, provided that the plans can identify services provided at the individual spots.

The reservation execution unit 1011 determines a combination of spots to be used by the user during a trip, and plans to be used at the respective spots. Each of the plans thus determined is associated with the date and time at which the spot concerned is used. These items of information will be called “itinerary”. The reservation execution unit 1011 generates data (reservation data) for making reservations for the spots, according to the itinerary thus generated, and sends the data to external devices corresponding to the respective spots. In this manner, the user can make reservations all at once for the facilities, etc. to be used during the trip.

The coupon issuing unit 1012 issues electronic coupons that can be used by users, based on the status of reservations made by the users for spots. In this embodiment, when the number of users who have reserved a spot in a given area exceeds a predetermined value, the coupon issuing unit 1012 issues electronic coupons that can be used in the area, and sends the coupons to the user terminals 200 corresponding to the users who will visit the area. The electronic coupon may be data that can be transmitted between mobile terminals, or those such as a bar code and a two-dimensional code, which can be optically read. The electronic coupon may also be image data. A specific method of issuing the electronic coupons will be described later.

The storage unit 102 incudes a main storage device and an auxiliary storage device. The main storage device is a memory in which programs executed by the controller 101 and data used by the control programs are developed. The auxiliary storage device is a device in which programs executed by the controller 101 and data used by the control programs are stored.

The storage unit 102 also stores spot data 102A, plan data 102B, reservation data 102C, and coupon data 102D.

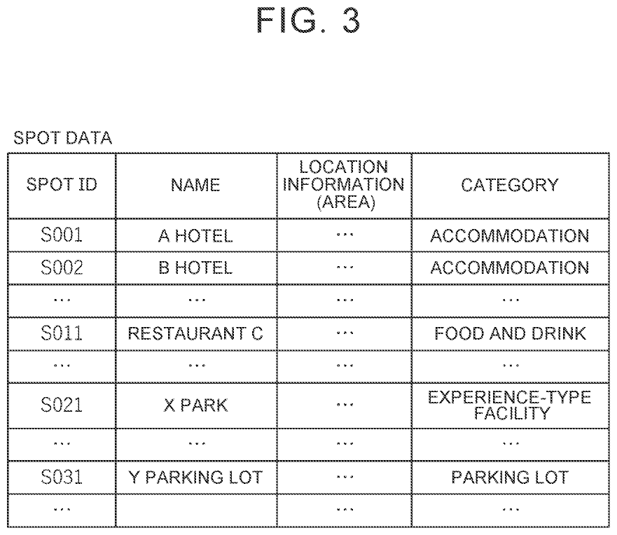

The spot data 102A is data that defines a plurality of spots used by users. FIG. 3 is an example of the spot data 102A. The spot data 102A includes, for example, the identifiers of the spots, names of the spots, location information corresponding to the spots (areas where the spots exist), and information concerning the category.

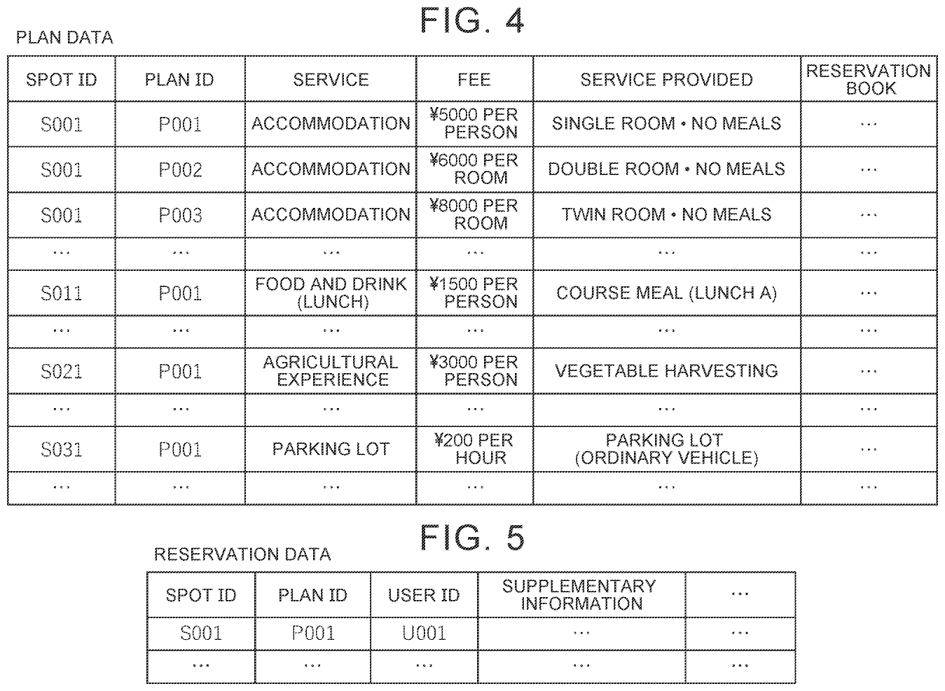

The plan data 102B is data that defines services (plans) provided at each of the spots. FIG. 4 is an example of the plan data 102B. The plan data 102B includes, for example, the identifiers of the spots, identifiers of the plans, data concerning the contents and fees of the services provided.

When there is a limitation to the resource (e.g., the number of rooms or seats) for the service that can be provided at each spot, it may be necessary to check availability before accepting a reservation. To deal with this situation, the plan data 102B may also include data used for determining whether a reservation can be made. One example of the data is a reference to a reservation book. By accessing the reservation book via the data, the reservation execution unit 1011 can present the possibility of making the reservation to the user. The reservation book may be possessed by the reservation server 100, or may be possessed by an external device corresponding to each spot.

The reservation data 102C is generated by the reservation execution unit 1011. The generated reservation data is temporarily stored in the storage unit 102 until it is sent to an external device. FIG. 5 is an example of the reservation data 102C. The reservation data 102C includes information that identifies the combination of spot, plan, and user, and supplementary information. Examples of the supplementary information include the reservation time (arrival time, check-in time), the number of users, the age and gender of each user, and contact information of the user.

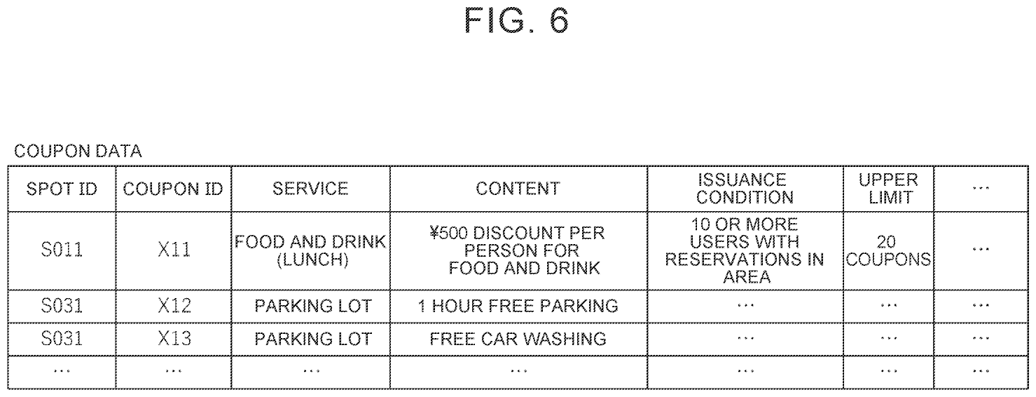

The coupon data 102D is data that defines incentives (typically, electronic coupons) provided to the users at a plurality of spots. FIG. 6 is an example of the coupon data 102D in the first embodiment. The coupon data 102D includes, for example, the identifiers of the spots, identifiers of the coupons, types of the services offered in the coupons, and data concerning the contents of the coupons. The type of the service may be, for example, the accommodation facility, restaurant, entertainment facility, parking lot, etc. The type of the service may be further subdivided into those such as breakfast, lunch, and dinner.

The content of the coupon is set for each spot. For example, when the spot is an accommodation facility, a room upgrade, free (or discounted) meal, other additional services (e.g., video on demand (VOD) service, room service, welcome drink service), etc., may be provided. When the spot is a restaurant, for example, a free (or discounted) food, extended usage time, other additional services, etc. may be provided. When the spot is related to automobiles, for example, when the spot is a parking lot, gas station, or car wash, services related to automobiles may be provided. Examples of the services include a free (or discounted) parking fee, and free (or discounted) services such as car washing, fueling, and interior cleaning.

The coupon data 102D includes data concerning coupon issuance conditions. An example of the coupon issuance conditions is that “20 or more users (reserving a spot) are present in the area”. In this case, when there are 20 or more users reserving any spot in the area concerned, the corresponding coupon is issued. The coupon data 102D may further include data concerning the maximum number of coupons to be issued. For example, when the upper limit is 20 coupons, the coupons are issued to a maximum of 20 users. The coupon data 102D may also include electronic data transmitted to the user terminals 200, or data used for generating the electronic data.

Each item of the above data may be constructed by managing data stored in the storage device, according to a program of a database management system (DBMS) executed by a processor. In this case, each data may be a relational database, for example.

The communication unit 103 is a communication interface for connecting the reservation server 100 to a network. The communication unit 103 includes, for example, a network interface board, or a wireless communication interface for wireless communication.

The configuration shown in FIG. 2 is one example, and all or some of the functions illustrated in FIG. 2 may be implemented using specially designed circuits. Also, a combination of main storage device and auxiliary storage device other than those illustrated in the figures may be used to store and execute the programs.

Next, processes performed by the reservation server 100 will be described. The reservation server 100 performs two types of processes, i.e., a process (first process) of making a reservation for a spot based on a request from the user, and a process (second process) of issuing an electronic coupon based on the reservation status for each area.

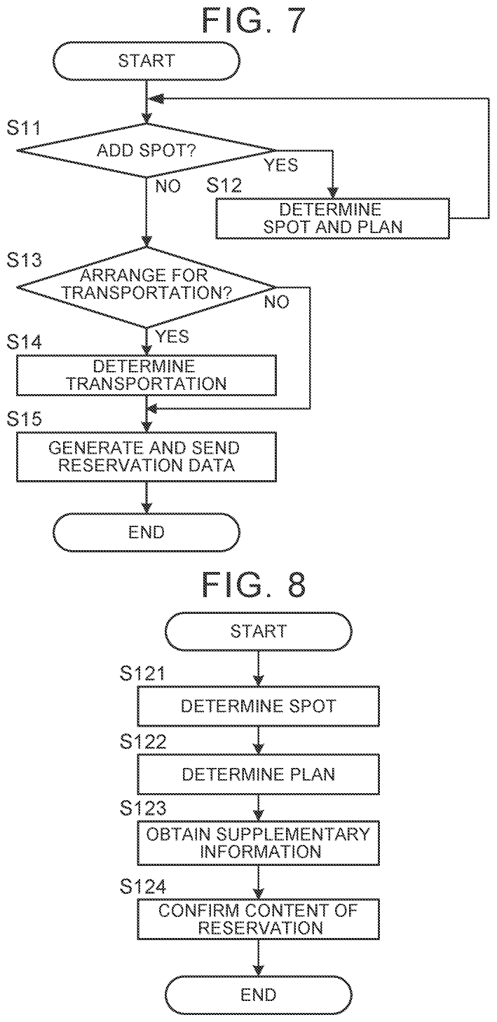

FIG. 7 is a flowchart illustrating the first process. The process of the flowchart shown in FIG. 7 is carried out at a time when the user logs in to the reservation service, for example. At the time when the process is started, the reservation server 100 assumes that the identification of the user has been completed.

In steps S11 to S14, the reservation execution unit 1011 create the itinerary. The itinerary is created by adding one or more spots, and then determining the means of transportation. In step S11, the reservation execution unit 1011 determines whether to add a spot. In this step, a request concerning a reservation for an accommodation facility, restaurant, entertainment facility, experience-type facility, parking lot, or the like, is obtained from a user. When an affirmative decision (YES) is obtained in this step, the control proceeds to step S12. When a negative decision (NO) is obtained in this step, the control proceeds to step S13.

In step S12, the spot and plan used by the user are determined. A process performed by the reservation execution unit 1011 in step S12 will be described in more detail, with reference to FIG. 8.

Initially, in step S121, a spot (e.g., accommodation facility) to be used is determined. When the spot added is an accommodation facility, the reservation execution unit 1011 provides a search screen for accommodation facilities, and allows the user to search available accommodation facilities, in step S12.

In step S122, a plan is determined. The plan may be searched for by use of a known technology. For example, a list of plans may be provided, according to search conditions entered via a screen, for example, to allow the user to select one or more of the plans. The plan that can be reserved may be determined by referring to the plan data 102B and the reservation book, for example.

Then, in step S123, supplementary information concerning the use (supplementary information) is obtained. When the spot is an accommodation facility, date and time information (in this example, the check-in date and check-in time), the number of guests, the age and gender of each guest, etc. are obtained as the supplementary information.

In this example, the spot is an accommodation facility. When the spot is a facility other than accommodation, such as a restaurant, entertainment facility, experience-type facility, or parking lot, supplementary information that matches the spot may be obtained in step S12. For example, when the spot is a parking lot, the supplementary information may be information related to a vehicle. When the spot is an experience-type facility, the supplementary information may be information concerning the age of a participant. In step S124, the content of the reservation is confirmed based on the user's input.

Returning to FIG. 7, description will be continued. When addition of the spot is completed, the process returns to step S11, and the reservation execution unit 1011 determines whether another spot needs to be added. When another spot is added, step S11 and step S12 are repeatedly executed.

The flowchart of FIG. 7 shows an example of adding two or more spots sequentially. However, before starting to create the itinerary, the user may be asked to specify a condition or conditions, and combinations of spots and plans that match the specified conditions may be automatically extracted and presented. The conditions may include, for example, the area to be traveled, departure point, departure date and time, spots which the user wishes to visit, categories of the spots which the user wishes to visit, return date and time, etc. In this manner, a recommended itinerary can be automatically created. The itinerary thus created may be editable by the user. For example, the user may add, delete and replace one or more spots, and replace plans, for example.

In step S13, the reservation execution unit 1011 determines whether to arrange for transportation. When arranging for transportation, the reservation execution unit 1011 determines a transportation to be used and its details in step S14, via a user interface screen. In this step, the departure point, destination, route, transportation to be used, etc. are determined. When a transportation that requires reservation is used, the availability may be checked in this step, through communication with an external device in charge of the transportation. The external device may provide reservation services for trains, airplanes, taxicabs, rental cars, and so forth. When the reservation execution unit 1011 determines in step S13 that no arrangement for transportation is made, the process of presenting a screen related to arrangement for transportation and making a reservation for transportation is skipped. In this case, the reservation execution unit 1011 may execute the reservations, at the time when the spots and plans to be used are confirmed.

In this connection, two or more means for transportation may be used during a trip. For example, the user may move to an area as a destination by train, for example, and then move in the area using a rental car. In this case, a facility that provides means for transportation (e.g., a taxicab or car rental office) may be treated as a spot. In this case, the spots and plans may be determined, by a process similar to that of step S12

In step S15, the reservation execution unit 1011 creates data (reservation data) for reserving the spots (and transportation) to be used by the user. In this step, the reservation data as illustrated in FIG. 5 is created, and sent to an external device or devices respectively corresponding to one or more spots (or transportation) to be used by the user.

Through the process as described above, the reservation server 100 can accept reservations for a plurality of spots, from a plurality of users.

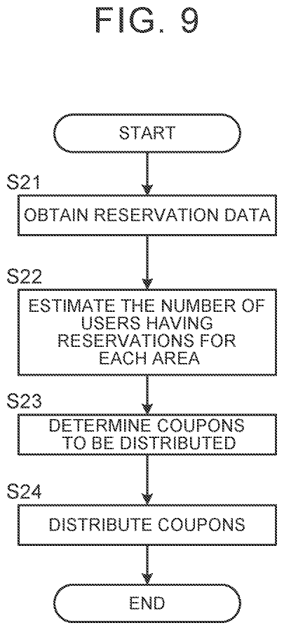

Next, the process (second process) in which the reservation server 100 issues electronic coupons will be described. FIG. 9 is a flowchart of the process in which the reservation server 100 issues electronic coupons based on the reservation status of spots. The process illustrated in FIG. 9 is executed by the coupon issuing unit 1012, in predetermined timing.

Initially, in step S21, the coupon issuing unit 1012 obtains the reservation data 102C. The data to be obtained may be set to data for the same day, for example. Then, in step S22, the number of users having reservations is counted for each area. For example, the coupon issuing unit 1012 counts the number of users matching the following conditions for each of two or more areas, and estimates the number of users who reserve any spot in each area.

(1) The user reserves a spot located in a target area.
(2) The reservation date and time are within a predetermined range ahead of and behind the current time.
The two or more areas may be divisions in the form of a mesh, or administrative divisions.

In step S23, the coupon issuing unit 1012 determines coupons to be distributed. In this step, when the spot corresponding to the coupons meets the following conditions, the coupons are determined to be distributed.

(1) The spot is located within the target area.
(2) The number of users (estimated in step S22) present in the area concerned satisfies an issuance condition defined by the coupon data 102D.

Then, in step S24, the coupons thus determined are distributed to the users. The users to whom the coupons are to be distributed may be, for example, (1) users present in the area associated with the coupons, or (2) users who can arrive at the area associated with the coupons within a predetermined time (e.g., within one hour). When the maximum number of coupons issued is specified, the coupons are distributed according to the maximum number.

When the reservation server 100 can obtain location information of the user terminals 200, the reservation server 100 can determine the user terminals 200 to which the coupons are distributed, based on the obtained location information. Thus, the reservation server 100 may periodically collect the location information of a plurality of user terminals 200. The location of the user may also be estimated based on the itinerary generated by the reservation server 100. For example, when there is a user who reserves a spot in a certain area, it can be presumed that the user is present in the area at the reservation time. Also, when the route along which the user travels is known, such as when the reservation server 100 provides a route finding service, the location of the user at each point in time can be estimated.

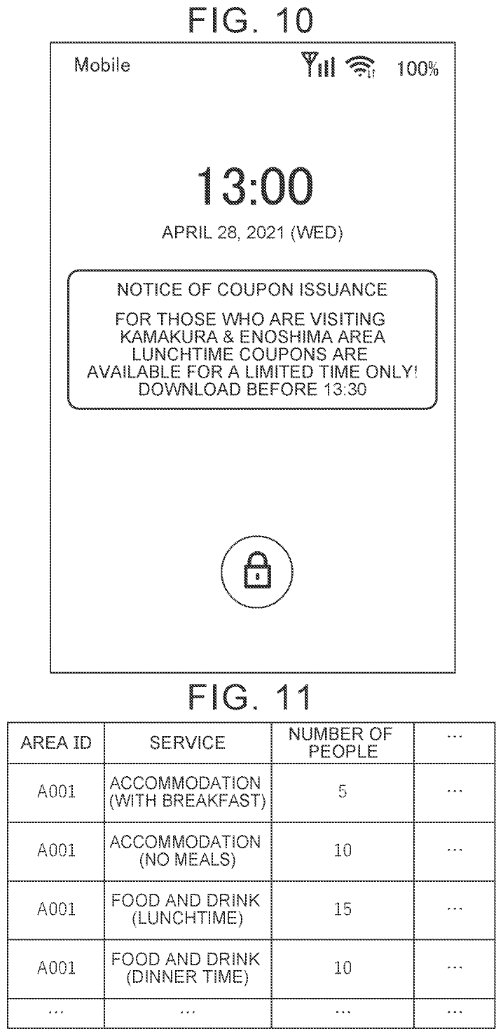

The coupons may be distributed by push sending electronic data of the coupon to the user terminals 200 associated with the users. Also, the user terminal 200 may be notified that the coupons are distributed at a given website, etc., and the user may be directed to the website, etc., to download the coupon. The downloading may be permitted only within a predetermined time (e.g., within one hour from the notification). Furthermore, the coupon may have an expiration time (e.g., within one hour from the issuance). FIG. 10 is one example of the notification sent to the user terminal 200.

As described above, in the first embodiment, the number of users who are staying in a given area to receive services is estimated, based on data generated when the users reserve spots, and electronic coupons that can be used in the area are issued when the number of the users exceeds a predetermined value. With this configuration, as a larger number of people are gathering in a given area, the incentives for encouraging more consumption can be issued.

### Modified Example of First Embodiment

In the first embodiment, the threshold value of the number of people, which is a condition for issuing coupons, is set to a uniform value. However, in some cases, it is desirable that the threshold value of the number of people varies in accordance with circumstances. Thus, the threshold value may be set based on the current circumstances of a target area. For example, the weather, temperature, amount of precipitation, amount of snowfall, etc. may be used as the current circumstances. For example, when the area concerned is under circumferences that make it difficult for people to gather, such as bad weather, the threshold value may be corrected to be lowered. Data indicating the circumstances of the area may be obtained from an external device that provides weather information, for example.

### Second Embodiment

In the first embodiment, whether to issue coupons is determined based on the number of users present in the area. However, in some cases, it is not desirable to provide coupons for services similar to those reserved by the users. For example, in an area where many users have reservations for meals during lunch time, it is not appropriate to further distribute coupons related to lunch. To deal with this situation, in the second embodiment, the number of users is estimated for each service reserved.

In the second embodiment, in step S22, the coupon issuing unit 1012 counts the number of users for each area and for each service. As a result, the aggregate results as shown in FIG. 11 are obtained. The services may be classified into categories such as accommodation, and food and drink, or may be classified by time of day into categories such as lunch time, and dinner time.

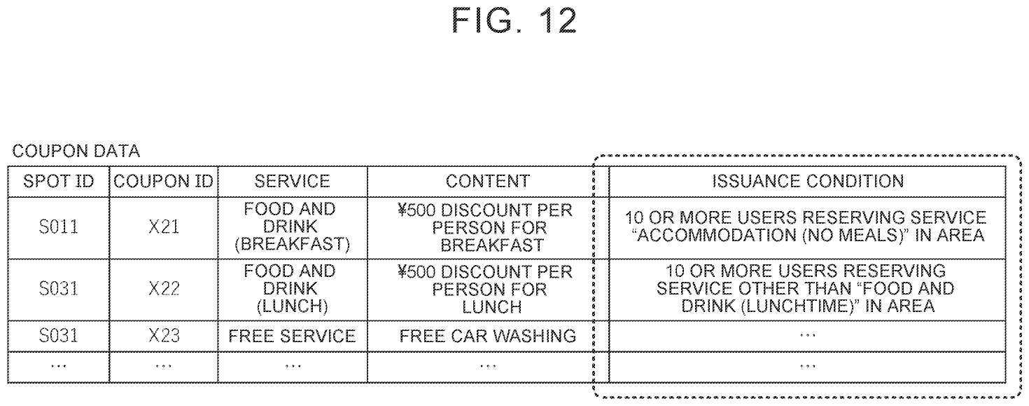

In the second embodiment, conditions related to services are added to the conditions for issuing coupons, as shown in FIG. 12. For example, “the number of users having reservations for services called “accommodation (no meals) in the area”, or “the number of users having reservations for services other than “food and drink (lunch time) in the area” may be used as a condition for issuing coupons. Then, in step S23, whether to issue coupons is determined based on the number of people for each service. With this configuration, it is possible to determine whether coupons are to be issued, based on the number of users who are receiving a particular service in the area, or the number of people who are not receiving a particular service.

### Third Embodiment

In the first and second embodiments, the coupons issued are distributed to the users who can visit a target area. On the other hand, in some cases, it is not desirable to unconditionally offer the users coupons. For example, at an accommodation facility, food and drink coupons from other restaurants that can be used during the morning hours should not be distributed to the users who have reserved an accommodation plan including breakfast. To deal with this situation, in the third embodiment, the users to whom coupons are distributed are individually selected through filtering.

In the third embodiment, in step S24, the coupon issuing unit 1012 determines for each user whether the service mentioned in the coupon is of the same type as the service reserved by the user, and does not distribute or offer the coupon to the user who has booked the same type of service. The service mentioned in the coupon can be determined by referring to the coupon data 102D. Also, the service reserved can be determined by referring to the reservation data 102C. For example, when the service reserved by a certain user is “food and drink (lunch)”, and the service mentioned in the coupon is “food and drink (lunch)”, the coupon is not distributed to the user. Thus, it is possible to avoid a situation where the coupon referring to the service that overlaps the service ready to be received by the user is distributed to the user.

### Fourth Embodiment

In the first to third embodiments, whether to provide coupons that can be used in a given area is determined, based on the number of users present in the area. In the meantime, when the traveling route of each user can be obtained or estimated, whether to provide coupons that can be used in a given area may be determined, based on the number of users who will pass through the area.

For example, when the reservation server 100 provides a route finding service, and the traveling routes of users are known, the number of users who will pass through a certain area in a certain time slot can be determined. Furthermore, even if the route is not known, the traveling route of the user to a reserved spot can be estimated if the departure point (e.g., the address) of the user is known.

Then, whether to provide coupons that can be used in a certain area may be determined, based on the number of the users who will pass through the area in a given time slot. For example, when there is a user who is traveling from area A to area C via area B, so as to receive a service reserved, and the user have time to spare before the reservation time, it is possible to offer the user a coupon that can be used in the area B on the way, and have the user use the coupon.

### MODIFIED EXAMPLES

The above embodiments are mere examples, and the disclosure may be embodied with changes as needed, without departing from its principle. For example, the processes and means described in the disclosure may be freely combined and implemented, unless any technical inconsistency arises.

While examples where electronic coupons are distributed to users are illustrated in the embodiments, the type of the incentive is not limited to coupons. For example, when a given condition is satisfied, the user may be notified of a time sale that is held at a given spot. Furthermore, whether or not the time sale is to be held may be determined based on the number of users.

While the number of users present in a particular area is counted in real time in the embodiments, the number of users who will be present in a particular area at a particular point in the future may be estimated. This makes it possible to make a plan for issuing coupons in advance. It is also possible to give advance notice of coupon distribution, for example. While two or more spots are individually reserved in the illustrated embodiments, the reservation server 100 may sell a travel product that includes a set of two or more spots or plans. In this case, a coupon for a service that is not included in the travel product may be issued to the user.

While the service that makes reservations for two or more spots is illustrated as the first service in the embodiments, the first service may be a service that does not involve reservation (for example, service that only provides information). For example, the first service may be a service that searches for two or more spots where coupons are provided. In this case, the number of users in an area may be estimated, according to the status of coupon acquisition, etc. Thus, if the number of users who will receive (or who are receiving) a service at a particular spot can be determined, the information processing device may use data other than the reservation data. In addition, users may be asked to declare that they are heading for a certain spot or area, and coupons in the corresponding area may be distributed to the users, based on the results of declaration.

The process described as being performed by a single device may be shared and performed by two or more devices. Alternatively, the processes described as being performed by different devices may be performed by a single device. In a computer system, the type of hardware configuration (server configuration) that implements each function can be flexibly changed.

The disclosure can be realized by supplying a computer program installed with the functions described in the above embodiments, to a computer, and causing one or more processors of the computer to read and execute the program. Such a computer program may be provided to the computer by a non-transitory computer-readable storage medium that can be connected to a system bus of the computer, or may be provided to the computer via a network. The non-transitory computer-readable storage media include, for example, any type of disk such as a magnetic disk (floppy disk (registered trademark), hard disk drive (HDD), etc.), and an optical disk (CD-ROM, DVD disk, Blu-ray disk, etc.), read-only memory (ROM), random access memory (RAM), erasable programmable read-only memory (EPROM), electrically erasable and programmable read-only memory (EEPROM), magnetic card, flash memory, optical card, and any type of medium suitable for storing electronic instructions.

What is claimed is:

1. An information processing device comprising
a controller configured to:
obtain data related to a service received by each of a plurality of users at one or more spots; and
determine an incentive provided in a given area, based on the number of the users each receiving the service at the one or more spots included in the given area.

2. The information processing device according to claim 1, wherein the data includes reservation data related to reservations made by the users for the one or more spots.

3. The information processing device according to claim 2, wherein the reservation data includes information that identifies a target spot to be reserved, and a reservation time.

4. The information processing device according to claim 2, wherein the controller is configured to make an estimation of the number of the users each staying to receive the service in the given area, based on the reservation data, and determine the incentive, based on a result of the estimation.

5. The information processing device according to claim 4, wherein the controller is configured to determine that the incentive is provided, when the number of the users staying in the given area exceeds a predetermined value.

6. The information processing device according to claim 5, wherein the predetermined value is set based on current circumstances of the given area.

7. The information processing device according to claim 3, wherein the reservation data further includes information that identifies a content of the service received by each of the users.

8. The information processing device according to claim 7, wherein
the controller is configured to identify the service received by each of the users staying in the given area, and
the controller is configured to determine the incentive, based on the number of the users for the service.

9. The information processing device according to claim 1, wherein the controller is configured to send the determined incentive, to user devices corresponding to the users located in the given area.

10. The information processing device according to claim 1, wherein the controller is configured to send the determined incentive, to user devices corresponding to the users each scheduled to receive the service in the given area.

11. The information processing device according to claim 1, wherein the controller is configured to send the determined incentive, to user devices corresponding to the users each scheduled to receive a service other than a service offered by the incentive.

12. The information processing device according to claim 1, wherein the incentive includes a discount or free service provided in any of the one or more spots included in the given area.

13. The information processing device according to claim 12, wherein the controller is configured to generate electronic data corresponding to the incentive.

14. An information processing method executed by a controller, the information processing method comprising:
obtaining data related to a service received by each of a plurality of users at one or more spots; and
determining an incentive provided in a given area, based on the number of the users each receiving the service at the one or more spots included in the given area.

15. The information processing method according to claim 14, wherein the data includes reservation data related to reservations made by the users for the one or more spots.

16. The information processing method according to claim 15, wherein:
the reservation data includes information that identifies a target spot to be reserved, and a reservation time; and
determining the incentive includes making an estimation of the number of users each staying to receive the service in the given area, based on the reservation data, and determining the incentive, based on a result of the estimation.

17. The information processing method according to claim 15, wherein:
the reservation data includes information that identifies a target spot to be reserved, a reservation time, and a content of the service received by each of the users; and
determining the incentive includes identifying the service received by each of the users staying in the given area, and determining the incentive, based on the number of the users for the service.

18. The information processing method according to claim 14, further comprising sending the determined incentive, to user devices corresponding to the users located in the given area.

19. The information processing method according to claim 14, further comprising sending the determined incentive, to user devices corresponding to the users each scheduled to receive the service in the given area.

20. The information processing method according to claim 14, wherein the incentive includes a discount or free service provided in any of the one or more spots included in the given area.
